(19) United States
(12) Patent Application Publication
(10) Pub. No.: US 2010/0330366 A1
(43) Pub. Date: Dec. 30, 2010

(54) SILICA-BASED PARTICLE COMPOSITION

(76) Inventors: Bruce A. Keiser, Plainfield, IL (US); Timothy S. Keizer, Aurora, IL (US); James H. Adair, State College, PA (US)

Correspondence Address: NALCO COMPANY, 1601 W. DIEHL ROAD, NAPERVILLE, IL, 60563-1198, US

(21) Appl. No.: 12/495,080

(22) Filed: Jun. 30, 2009

(51) Int. Cl. B32B 1/00; C07F 7/02; C07F 5/02

(52) U.S. Cl. 428/402; 549/214; 549/215; 549/213; 977/773

(57) ABSTRACT

The present invention relates to a method for forming a silica-based particle or composite consisting of a silica-based material, an active, with or without a surface modification, and the related composition. The silica-based particle is illustrated by the formula (SiO₂)ₓ(OH)_{y}R_{z}Sₜ, whereby R is an active or actives such as an organic or inorganic molecule that includes markers, amines, thiols, epoxies, organosilicones, organosilanes, and water soluble agents and, optionally, a surface modifier, S, which may be either organic, polymeric, or inorganic. Examples of a surface modifying material are inorganic salts of aluminum and boron or organic materials such as organosilanes or low molecular weight polymers. As such, the particle can be used in a variety of applications including any of a variety of high temperature, at acidic, neutral, or basic pH, or pressure environments. The composites have applications as diverse as papermaking, water treatment, chemical tracing, personal care, microbiological control, and delivery of polymers, for example. With regard to papermaking, the particle provides retention and drainage performance while delivering whitener, or OBA, other functional additives and serves an additive tracker.

### TECHNICAL FIELD

This invention relates generally to a method for forming a silica-based composition with an active, and the resultant silica-based composite composition, as well as sols formed therefrom. In particular, the present invention relates to a method of forming a silica-based composition containing one or more actives.

### BACKGROUND

In the papermaking art, an aqueous suspension containing cellulosic fibers, and optional fillers and additives, referred to as stock, is fed into a headbox, which ejects the stock onto a forming wire. Water is drained from the stock through the forming wire so that a wet web of paper is formed on the wire, and the paper web is further dewatered and dried in the drying section of the paper machine. Drainage and retention aids are conventionally introduced into the stock in order to facilitate drainage and to increase adsorption of fine particles onto the cellulosic fibers so that they are retained with the fibers on the wire.

In order to minimize the resultant effluent load, it is important to ensure that as much fine material and colloidal material as possible is removed with the paper web itself, rather than passing into the sewer. It is therefore important to understand the mechanisms in place whereby fine particle and colloidal retention can be maximized without sacrificing paper quality. This is, in essence, the usage of a micro-particle effect strategy. Although strategies can be utilized to guarantee good first pass retention of all furnish components, the micro-particle effect, recently referred to as nanoparticle effect, allows for reflocculation of cellulose-containing slurry. This provides for significant efficiency improvements related to fiber recovery and other additives even if the effluent consistencies are unchanged. As such, the nanoparticies are desired for use as drainage and retention aids.

The term micro-particle was first applied to a system utilizing cationic starch and an anionic colloidal silica. Silica-based particles are widely used as drainage and retention aids in combination with charged organic polymers like anionic and cationic acrylamide-based polymers and cationic and amphoteric starches. Such additive systems are disclosed in U.S. Pat. Nos. 4,388,150; 4,961,825; 4,980,025; 5,368,833; 5,603,805; 5,607,552; 5,858,174; and 6,103,064. These systems are among the most efficient drainage and retention aids now in use. Such silica-based particles are normally supplied in the form of aqueous colloidal dispersions, which are known as sols. Commercially used silica-based sols usually have silica content of between about 75% and about 15% by weight of the product. The silica-based sols are in the form of a dispersion of particles with a specific surface area of at least 30 m²/g. The dispersed particles of the sol being composed of silicon dioxide (SO₂) and water with inorganic impurities such as potassium, aluminum, titanium, and iron to name a few. Additionally, these references teach silica-based sols as dispersions of particles whose composition is based on silicon dioxide and water with added elements such as aluminum and/or boron to alter the particle surface charge. As such, known silica-based compositions include dispersions of particles that are usually more dilute which improves storage stability and avoids gel formation. It is desired, however, to produce sols having a higher concentration of silica. It is further desired to have a sol that carries a variety of actives and that can be readily altered.

Thus, there is a need in the art for the ability to provide silica-based sols that can function to carry other “actives” into the final article and provide drainage and retention performance. Preferably, such compositions will have enhanced stability. It would also be advantageous to be able to provide a process for preparing such silica-based sols and particles with improved drainage, retention, and stability properties. Further, there is a need for development of a method to prepare silica-based sols containing various actives as an additive that imparts improved drainage and retention during the formation of cellulose-containing articles. An example of such actives are fluorescent “actives” incorporated into the silica-based particles such that the quantum yield is increased and quenching of the fluorescent active is decreased. If an active can be carried and shielded from the environment the fluorescent active would no longer interfere with the performance of other additives or retention and drainage additives present in the cellulose-containing slurry. Thereby a silica-based composition is desired which incorporates fluorescent material into the colloidal silica-based particle such that the quantum yield is increased and quenching of the fluorescent probe is decreased.

### SUMMARY

The present invention relates to the manufacture of silica-based particle compositions, including particles and composites, prepared from (i) the combination of silica-based reactants, actives, and surface modifiers as desired or (ii) pre-existing silica-based or silica or borosilicate particle sols by the further reaction with silica-containing reactants, actives, and surface-modifiers to yield aqueous dispersions of particles having a general formula, (SiO₂)ₓ(OH)_{y}R_{z}Sₜ, wherein R is defined as an active selected from markers, amines, thiols, epoxies, organosilicones (or organosilanes), water soluble agents, the reaction product of such actives, and/or combinations thereof, and wherein S is defined as a surface modifier selected from inorganic, polymeric and organic compounds.

Inorganic surface modifiers may include various compound and salts of aluminum, zirconium, titanium, zinc, cerium, boron, lithium, iron, and combinations thereof. Polymeric surface modifiers may include polyamines, polyacrylates, polyethylene glycol, polyethylene oxide, polyethylene imines, poly quaternary amines, polyphosphonates, polysulfonates, and combinations thereof. Organic surface modifiers may include carboxylic acids, amines, phosphonates, organosilicones (or organosilanes), glycols, nonionic surfactants, quaternary amines, and combinations thereof. In the general formula, the weight ratio of hydroxyl to silicon dioxide, y/x, is from 0.2 to 0.5; the weight ratio of active to silicon dioxide, z/x, is from 0.0001 to 0.20; and, the weight ratio of surface modifier to silicon dioxide, t/x, is 0 to 0.5.

Markers are defined as various fluorophores or dyes and may be represented by but not limited to a compound which includes fluorescein, rhodamine B, fluorophore, fluorophane, tetrasodium 1, 3, 6, 8, pyrenetetra sulfonate, optical brightening agents or fluorescent whitening agents used in papermaking, and organic and inorganic dyes such as acid dyes, reactive dyestuffs, direct dyestuffs, dye fixing agents, orange HE dyes, black HE dyes, and bifunctional reactive dyes. Exemplary fluorescein and fluorescein derivatives include, without limitation, BDCECF; BCECF-AM; Calcien-AM; 5,(6)-carboxy-2′,7′-dichlorofluorescein; 5,(6)-carboxy-2′7′-dichlorofluorescein diacetate N-succinimidyl ester; 5,(6)-carboxyeosin; 5,(6)-carboxyeosin diacetate; 5,(6)-carboxyfluorescein; 6-carboxyfluorescein; 5,(6)-carboxyfluorescein acetate; 5,(6)-carboxyfluorescein acetate N-succinimidyl ester; 5,(6)-carboxy fluorescein N-succinimidyl ester; 5,(6)-carboxyfluorescein octadecyl ester; 5,(6)-carboxynaphthofluorescein diacetate; eosin-5-isothiocyanate; eosin-5-isothiocyanate diacetate; fluorescein-5,(6)-carboxamidocaproic acid; fluorescein-5,(6)-carboxamidocaproic acid N-succinimidyl ester; fluorescein isothiocyanate; fluorescein isothiocyanate isomer 1; fluorescein isothiocyanate isomer 2; fluorescein isothiocyanate diacetate; fluorescein octadecyl ester; fluorescein sodium salt; napthofluorescein; napthofluorescein diacetate; N-octadecyl-N′-(5 fluoroesceinyl) thiourea (F18), indocyanine green or indocarbocyanine.

Amines are defined as various organic nitrogen-containing compounds such as primary, secondary, tertiary and quaternary amines, the latter also referred to as quaternary ammonium compounds. The amines can be aromatic (i.e., containing one or more aromatic groups) as well as aliphatic amines. The nitrogen-containing compound is preferably water-soluble or water dispersible. Organic nitrogen-containing compounds usually have a molecular weight below 1,000 and contain up to 25 carbon atoms. The amines of the current invention may also contain one or more oxygen-containing substituents such as hydroxyl groups and/or alkyloxy groups. The organic nitrogen-containing compounds may also include one or more amines. Examples include alkylamines (e.g., ethylamine or propylamine), secondary amines (e.g., dialkylamines such as diethylamine), dialkanolamines such as diethanolamine, and tertiary amines such as triethylamine, or trialkanolamines such as triethanolamine. Examples of suitable quaternary amines are tetraalkanolamines such as tetraethanol ammonium hydroxide or N,N-dimethylethanolamine.

Thiols are represented generally by the class of organic and inorganic compounds containing the thiol group having the general formula —B—(SH), wherein B is a linear or branched group consisting of carbon atoms such as —(CH₂)ₙ—, wherein n is from 1 to 15, in particular where n is 1 to 6, and most preferred where n is 3. Examples of sulfur containing compounds would include but are not limited to trimercapto-s-triazine and thiocarbamates.

Expoxies of the present invention are generally a group of organic compounds that contain an epoxide ring within the molecule. An epoxide is a cyclic ether with only three ring atoms, one of which is an oxygen atom. The simplest epoxide is ethylene oxide, C₂H₄O. Other epoxides are known to the art with the following acting as an example: Glycidoxypropyltrimethoxysilane.

Organosilicones, organosilanes, or silane coupling agents are well known in the art and may be represented generally by R₍₄₋ₐ₎—SiXₐ, wherein a may be from 1 to 3. The organo-functional group, R—, may be any aliphatic or alkene containing functionalized group such as propyl, butyl, 3-chloropropyl and combinations thereof. X is representative of a hydrolysable alkoxy group, typically methoxy or ethoxy. Some examples of organosilicones or organosilanes are 3-glycidoxypropyl; 3-aminopropyl; dimethylaminopropyl; 3-thiopropyl; 3-iodopropyl; 3-bromopropyl; 3-chloropropyl; acetoxypropyl; 3-methacryloxypropyl; vinylpropyl; alkylcarboxylic acid; fluoresceinthioureapropyl; rhodaminethioureapropyl; hydroxybenzophenyl propyl ether; and mercaptopropyl silanes.

Water-soluble agents of the present invention can be described as organic polymers having a molecular weight of from about 100 to about 1,000,000 containing functionalities such as amines, carboxylic acids, phosphonates, sulfonates, or combinations thereof. Examples of water-soluble agents include but are not limited to polyacrylic acids, citric acid, and amino acids. The reaction products of silanes and other additives are also anticipated herein with an example of this type of material but not meant as a limitation being the reaction product between aminopropylsilane and fluorescein isothiocyanate.

Surface modifiers, S in the above formula, may also be present in the silica-based composite dispersion of the current invention. Surface modifiers alter the surface charge or character of the particle, for example, changing the particle surface to respond to a cationic, nonionic, or anionic charge. Available surface modifiers include inorganic and organic compounds and materials. Examples of inorganic compounds that can be used in the current invention include various compound and salts of aluminum, zirconium, titanium, zinc, cerium, boron, lithium, iron, and combinations thereof. Examples of organic compounds that may be used in the current invention to modify the silica-based composite surface include, but are not limited to, low molecular weight carboxylic acids, amines, phosphonates, organosilicones (or organosilanes), glycols, nonionic surfactants, quaternary amines, and combinations thereof. Anionic polyelectrolytes, which may be used in the practice of this invention, include polysulfonates, polyacrylates, and polyphosphonates. Such materials include naphthalene sulfonate formaldehyde (NSF) condensate. The polyelectrolytes of the current invention will have a molecular weight from 100 to about 1,000,000 with a charge density ranging from 1 to 13 milliequivalents/gram. Other examples include but are not limited to polyacrylate and copolymers of polyacrylates, polystrenesulfonate, polydiallyldimethylammonium chloride, polyethylene oxide, polyethylene imine, and phosphino polycarboxylic acid.

Further, the resulting silica-based particle composites having the general formula (SiO₂)ₓ(OH)_{y}R_{z} will have diameters ranging between 3 nm and 200 nm and a more specific particle size of between 5 nm and 100 nm, and more particularly between 10 mm and 30 nm. Preferably, the particles are about 20 μm. The particles are sometimes referred to as nanoparticles or nanocomposites. The particles comprise between 5% to 50% by weight SiO₂ and 0.02% to 2% by weight active. The particle of the current invention has a surface area ranging between 10 m²/g and 1,050 m²/g.

The base material of the particle composites (i.e., silicon dioxide), can be derived from silica, colloidal silica, polysilicate microgel, aluminosilicate, aluminum-modified-colloidal silica, ferrosilicate, borosilicate, titanium-silicate, natural clays, synthetic clays, acid sol, and combinations thereof. More specifically, the silicon dioxide used to form the particle composition can include acid sol, sodium silicate, tetraethylorthosilicate, silica, colloidal silica, polysilicate microgel, aluminosilicate, aluminum-modified-colloidal silica, ferrosilicate, borosilicate, titanium-silicate, natural clays, synthetic clays, and combinations thereof.

The method for forming the silica-based particle or composite composition with an active includes reacting a silicon dioxide composition with at least one active to form a silica-based particle composite. The surface of said particle composite may be modified by inclusion of surface modifiers either during synthesis or in a subsequent step. The silica-based particles thus formed in an aqueous composition constitute a sol.

The method for forming the silica-based particle composition with an active can include reacting a silica precursor with an active, in an acid sol, to form a silica-based particle coupled with an active or a primary particle composition. The primary particle composition can then have more acid sol and silica precursor/active added thereto to form the silica-based particle. A compound may be added to promote polymerization and formation of the composite particle.

Other actives or surface modifiers can be prepared by means of a reaction between silica precursors and selected compounds. An example would be the reaction of a silica-containing precursor and an organic compound in an appropriate mixed solvent prior to incorporation into the composite. A catalyst may be used during this synthesis. Such catalysts are known to the art and consist of, by example, inorganic bases such as NaOH, KOH, or NH₄OH. Further, the silica precursor and active are allowed to react for at least two hours. Added with the catalyst can be an amount of aluminum salt, borax, or an organic silane. The reaction temperature and reactant concentrations being controlled to result in the formation of the desired particle size, surface area, and composition of the precursor. As such, a dye coupled silica-based nanoparticle composition results whereby the composition has between 5% and 50% by weight SiO₂ and 0.02% to 2% by weight of dye.

Additional features and advantages are described herein, and will be apparent from, the following Detailed Description, Examples, and Figures.

### BRIEF DESCRIPTION OF THE DRAWINGS

This patent or application file contains at least one drawing executed in color. Copies of this patent or patent application publication with color drawing(s) will be provided by the U.S. Patent and Trademark Office upon request and payment of the necessary fee.

FIG. 1 shows a transmission electron microscopy (TEM) image of Fluorescein tagged silica.

FIG. 2 depicts a TEM image of Rhodamine B tagged silica.

FIG. 3 pictographically illustrates Rhodamine B tagged silica (red) (FIG. 3A) and Fluorescein tagged silica (yellow) (FIG. 3B) sols, along with the UV/Vis spectra (FIG. 3C).

FIG. 4 shows graphically the effects of bleaching Rhodamine B tagged silica (red) and Rhodamine B (blue) with sodium hypochlorite (FIG. 4A) and hydrogen peroxide (FIG. 4B).

FIG. 5 shows the fluorescent emission of particles in paper sheets including a dip-coated sheet (FIG. 5A), control sheet (FIG. 5B), and a hand sheet (FIG. 5C) exposed to UV light.

FIG. 6 shows magnified views of the fluorescent emission of particles in paper sheets including a dip-coated sheet (FIG. 6A) and a hand sheet (FIG. 6B).

### DETAILED DESCRIPTION

As used herein, the term “nanosize” refers to a special state of subdivision implying that a particle has an average dimension smaller than about 200 nm and exhibits properties not normally associated with a bulk phase (e.g., quantum optical effects). The term “nanocomposite” refers to a material that consists of both organic and inorganic materials and has nanosize dimensions. The silica-based particles described herein are, in an embodiment, nanosize or nanocomposite particles.

The chemical compound silicon dioxide, also known as silica or silox (from the Latin “silex”), is an oxide of silicon, chemical formula SiO₂. For purposes herein, the silica-based nanocomposites may contain in addition to silica and actives, other non-silicon elements such as but not limited to boron, aluminum, sodium, and the like. Organosilicon and organosilane compounds are organic compounds containing carbon silicon bonds (C—Si).

Thiourea is an organic compound of carbon, nitrogen, sulfur and hydrogen, with the formula CSN₂H₄ or (NH₂)₂CS. It is similar to urea, except that the oxygen atom is replaced by a sulfur atom.

The term “colloid” refers to a type of dispersion where one substance is dispersed evenly throughout another. A colloidal system consists of two separate phases: a dispersed phase (or internal phase) and a continuous phase (or dispersion medium), the dispersed phase being of inorganic materials.

Silica gel is a granular, porous form of silica made synthetically from sodium silicate. Despite the name, silica gel is solid.

The term “sol” refers to a colloidal suspension of solid particles (e.g., 1 to 200 nanometers in size or up to about 1 micron) in water.

The present invention relates to methods of forming sols of silica-based particles and actives, and the resultant compositions. In particular, the present invention relates to silica-based particle or composite compositions that are then included in a sol. In one embodiment, the particle of the invention is a nanocomposite or nanosize particle. Any of a variety of actives may be selected for use in the preparation of silica-based particles of the current invention including organic and inorganic molecules. Essentially, an active will be any composition that can be “carried” by the particle, with the composition performing a function such as whitening, coloration, dehydration, binding, or polymer formation. Suitable actives include markers, whitening agents, dyes, UV absorbers, chelants, or combinations thereof to name a few. The active or actives may be released upon the passage of time, a change in temperature, a change in environment (e.g., pH or conductivity), or another signal as identified by a skilled artisan.

One method of preparation of the silica-based particle or composite compositions of the present invention is accomplished typically in two steps whereby a particle precursor or primary particle composition is first formed. The precursor is formed by a coupling technique described in Van Blaaderen, A. and Vrij, A., “Synthesis and characterization of colloidal dispersions of fluorescent, monodisperse silica spheres” Langmuir 1992, 8, 2921. The precursor or active composition illustrated by the formula (SiO₂)ₓ(OH)_{y}R_{z} is incorporated by a direct synthesis technique described in U.S. patent Ser. No. 11/443,515, “Organically Modified Silica and Use Thereof,” now pending, and can be used as is, including in forming a sol, or can be further modified and treated.

This precursor composition can then be further reacted with silica-based reactant such as acid sol to form a particle composition of the formula (SiO₂)ₓ(OH)_{y}R_{z} containing multiple actives. The particle composition, also generally referred to as a silica-based particle, can then be combined with additional silica-based particles in aqueous solution. The silica-based particles can be used for a variety of uses dependent upon the active being carried by the particle. As such, the particle at a minimum includes an amount of SiO₂ from derivatives and family members, including sodium silicate, tetraethylorthosilicate, organic silane, silica, colloidal silica, acid sol, polysilicate microgel, aluminosilicate, aluminum modified-colloidal silica, ferrosilicate, borosilicate, titanium-silicate, natural clays, synthetic clays, and combinations thereof, in addition to hydroxyls and active(s) in the composition. The silica-based nanoparticle can be optionally modified or “coated” with an additional amount of SiO₂ or silica-based material. Thus, one method of the present invention includes binding the active to a silica-containing compound or trapping the active in the silica compound followed by further reaction with acid sol.

Stated another way, the method includes the formation of silica-based composites containing an active or actives with the resultant composite having an optional surface modification. The surface of the composites may be silica-based or a mixture of silica and active or actives. Other non-silicon elements, such as modifiers, may be added to the composite, these surface modifiers include salts of aluminum, boron, iron, cerium, zinc, lithium, zirconium, or combinations thereof. The surface modifiers alter the charge of the surface, which is dictated by the desired end uses. The particle surface can be designed to specifically respond to cationic, nonionic, or anionic environments.

The silica-based particle or composite sols can be used for a variety of industries and uses. The uses are dependent upon the particular organic or inorganic active selected. In particular, the silica-based composite can be readily used in any of a variety of high temperature, acidic or basic pH, or pressure environments. The silica-based composite provides sufficient protection from the environment such that the additive is delivered for a final use. As such, the composites of the invention have applications as diverse as papermaking, water treatment, chemical tracing, personal care, microbiological control, and delivery of polymers, to name a few. Specifically, the particle can deliver agents having limited water solubility or stability due to chemical, photochemical, or physical instability. With regard to papermaking the particle can deliver retention and drainage aids, whitener, or tracing elements.

The silica-based composite and related compositions, as well as sols formed therefrom function as drainage and retention aids in papermaking, preferably in combination with organic polymers. The term “drainage and retention aid,” as used herein, refers to one or more components (aids, agents, or additives) which, when being added to a papermaking stock or water suspension containing cellulose fibers, give better drainage and/or retention than is obtained when not adding the components. The present invention further relates to a process for the production of paper from an aqueous suspension containing cellulosic fibers, and optional fillers, which comprises adding to the suspension of silica-based composites followed by forming and draining the suspension on a wire.

Further, silica-based particle can be designed to, for example, work in conjunction with the cationic flocculants to retain paper fibers. Most cationic flocculants break apart from shear forces in a papermaking process. The silica-based particle re-flocculates slurries used in paper and board manufacture that contain cellulose fibers after shear forces break down of the original flocculent. The particles of the present invention can also facilitate the removal of water during the production of the cellulose-containing article. Finally, the particles can carry the actives used to track the particle throughout the manufacturing process.

The silica-based particles, which form the sols, are suitable for use as flocculating agents in water purification, and as drainage and retention aids in papermaking. The present silica-based particles and sols exhibit good stability over extended periods of time, notably high surface area stability, and high stability to avoid gel formation. Therefore, such particles can be prepared and shipped at high specific surface areas, small nanometer diameters, and high silica concentrations. The silica-based composite sols have improved capability to maintain the high specific surface area on storage at high silica concentrations. The silica-based composite sols and particles further result in very good or improved drainage and retention when used in conjunction with anionic, cationic, and/or amphoteric organic polymers, and combinations thereof to make cellulose-containing articles, such as paper or board products. The silica-based particles invention makes it possible to increase the speed of the paper machine and to use a lower dosage of additives to give a corresponding drainage and/or retention effect, thereby leading to an improved papermaking process while providing economic benefits. In many cases additional benefits from the “actives” contained therein include but are not limited to lower use levels, less competitive interaction with other process aids, and improved efficiency.

Fluorescent dyes may be one such active, which may be contained within the silica-based composite. In one method, the fluorophore is reacted with a silicon dioxide or derivative or an organic silane precursor and then incorporated into the silica utilizing the “direct synthesis” technique. The dye is covalently bound to the silica, which can reduce the leaching of the dye from the colloidal silica. Typically, a urea link is formed between the dye and the silicon dioxide derivative but not limited to. The silica composite will prevent self-quenching of the dye or active, as the dye is bound with the silica and not allowed to interact with the environment or other dye molecules. As such, the incorporation of the dye protects it from interacting with detrimental species in solution or a process stream. This incorporation is important as many additives in a process stream, for example the paper making process, will quench the fluorescence, such as cationic polymers. Also, pH changes may influence the efficiency of the dye or active. By incorporating in a silica-based particle, the active is protected from external factors.

The reaction for forming the silica-based composite and active is done in essentially two parts and is a direct synthesis technique. The reaction is initiated by reacting at ambient conditions a silica precursor with an active. Any of a variety of silica precursor compositions may be used, including a variety of SiO₂ derivatives and family members. Specific examples include sodium silicate, tetraethylorthosilicate, organic silane, silica, colloidal silica, polysilicate microgel, aluminosilicate, aluminum modified-colloidal silica, ferrosilicate, borosilicate, titanium-silicate, natural clays, synthetic clays, and combinations thereof. Generally, sodium silicate, and tetraethylorthosilicate are preferred.

The silica compositions are added in an amount equal to between about 2% and about 30% by weight of the starting composition. Mixed with the silica composition is at least one active. The active or actives are added in an amount equal to between about 0.02% and about 2%. This reaction is done in an anhydrous solution, such as methanol or ethanol. The solution is present in an amount equal to between about 0.1% and about 10% by weight of the starting composition and typically in an inert environment such as N₂. Typically, temperatures are reduced to about 0° C. to prevent gelation of the reaction mixture during synthesis. The reaction can be done as part of a batch process, and is allowed for a period of time (e.g., up to about 24 hours) sufficient to, in some cases, bond the active to the SiO₂ derivative carrier. As a result, a silica-based composite, particle, or precursor is formed of the formula (SiO₂)ₓ(OH)_{y}R_{z}. The precursor can be used to form a sol or can be further treated.

An additional amount of SiO₂ derivative or family member can be added to the silica-based composite, such as sodium silicate, silicic acid, or tetraethylorthosilicate. Added with the SiO₂ derivative may be an additional amount of active or actives. This is added to the (SiO₂)ₓ(OH)_{y}R_{z} precursor composition. Additionally, an amount of acid sol can be added. The acid sol and silica-based particle with an active composition in methanol are mixed together at a temperature sufficient to prevent gelling, typically 0° C. The acid sol/silica-based particle active composition is then added to water in a reactor vessel. The water will contain an amount of a catalyst. The catalyst can be selected from any of a variety of bases known in the art including NaOH, KOH, and NH₄OH. The base is added in an amount ranging between 0.01% and 1% by weight of the mixture. The mixture with the catalyst is then heated. Subsequently, additional acid sol may be added to the reaction vessel. The temperature at which this is done, as well as the concentration and rate, are controlled so as to result in the composition, particle size, and concentration desired. Finally, a composition of the formula (SiO₂)ₓ(OH)_{y}R_{z} is formed. The composition can be concentrated by any of a variety of methods known in the art such as ultra-filtration. Additional active or actives can be added with the acid sol, such as epoxies, amines, thiols and other compounds of interest to achieve the desired final particle composition. Here too, inorganic species such as boron and aluminum salts can be included. In this manner, the concentration of active(s), particle size, and composition of the particles can be controlled.

As such, smaller primary particles are grown with the active or dye coupled to the silicon dioxide derivative in an acid sol. Then secondly, more acid sol is optionally added to coat the primary particles. In addition, organosilicones or organosilanes such as 3-glycidoxypropyltrimethoxysilane may be used instead of or in conjunction with acid sol and incorporated in the surface modification of the silica-based composites. Examples of other materials that may be added are allyl, 3-glycidoxypropyl; 3-aminopropyl; dimethylaminopropyl; 3-iodopropyl; 3-thiopropyl; 3-bromopropyl; 3-chloropropyl; acetoxypropyl; 3-methacryloxypropyl; vinylpropyl; PEO; alkylcarboxylic acid; hydroxybenzophenyl propyl ether; fluoresceinthioureapropyl; rhodaminethioureapropyl; and mercaptopropyl.

As mentioned, the active or actives, designated as R, are incorporated into the silica-based composite and are protected from external interferences. For example, dyes can be incorporated and protected from bleaching agents and pH changes. Actives may also include markers such as fluorescein and related derivatives, rhodamine and derivatives, pigments, and dyes. Exemplary fluorescein and fluorescein derivatives include, without limitation, BDCECF; BCECF-AM; Calcien-AM; 5,(6)-carboxy-2′,7′-dichlorofluorescein; 5,(6)-carboxy-2′7′-dichlorofflorescein diacetate N-succinimidyl ester; 5,(6)-carboxyeosin; 5,(6)-carboxyeosin diacetate; 5,(6)-carboxyfluorescein; 5-carboxyfluorescein; 6-carboxyfluorescein; 5,(6)-carboxyfluorescein acetate; 5,(6)-carboxyfluorescein acetate N-succinimidyl ester; 5,(6)-carboxyfluorescein N-succinimidyl ester; 5,(6)-carboxyfluorescein octadecyl ester; 5,(6)-carboxynaphthofluorescein diacetate; eosin-5-isothiocyanate; eosin-5-isothiocyanate diacetate; fluorescein-5,(6)-carboxamidocaproic acid; fluorescein-5,(6)-carboxamidocaproic acid N-succinimidyl ester; fluorescein isothiocyanate; fluorescein isothiocyanate isomer 1; fluorescein isothiocyanate isomer 2; fluorescein isothiocyanate diacetate; fluorescein octadecyl ester; fluorescein sodium salt; napthofluorescein; napthofluorescein diacetate; or N-octadecyl-N′-(5 fluoresceinyl) thiourea (F18). The silica-based particles may be modified with different concentrations of the fluorescent dyes or actives and the particle size and structure controlled.

Exemplary rhodamine and rhodamine derivatives include, without limitation, 5,(6)carboxytetramethylrhodamine; 5-carboxytetramethylrhodamine N-succinimidyl ester; 6-carboxytetramethylrhodamine N-succinimidyl ester; 5,(6)-carboxytetramethylrhodamine N-succinimidyl ester; 5,(6)-carboxy-X-rhodamine; dihydrorhodamine 123; dihydrorhodamine 6G; lissamine rhodamine; rhodamine 110 chloride; rhodamine 123, rhodamine B hydrazide; rhodamine B; and rhodamine WT.

Exemplary organic pigments and dyes include, without limitation, hematoporphyrin dyes, such as 7,12-bis(1-hydroxyethyl)-3,8,13,17-tetramethyl-21H,23H-porphine-2 and 18-dipropanoic acid, and cyanine dyes and derivatives, such as indocyanine green; indoine blue; R-phycoerythrin (PE), PE-Cy 5; PE-Cy 5.5; PE-Texas Red; PE-Cy 7; Cy 3 NHS ester; Cy 3 maleimide and hydrazide; Cy 3B NHS ester; Cy 3.5 NHS ester; Cy 3 amidite; Cy 5 NHS ester; Cy-5; Cy 5 amidite; Cy 5.5; Cy-5.5 NHS ester; Cy 5.5 annexin V; Cy 7; Cy 7 NHS ester; Cy 7Q NHS ester; allophycocyanin (APC); APC-Cy 7; APC Cy 5.5; propidium iodide (PI); crystal violet lactone; patent blue VF; brilliant blue G; or cascade blue acetyl azide.

The (SiO₂)ₓ(OH)_{y}R_{z} can further be modified using a surface modifier. The surface modifiers form a product that is (SiO₂)ₓ(OH)_{y}R_{z}Sₜ, wherein Sₜ is a surface modifier. The surface modifiers include organic, polymeric and inorganic compounds. The inorganic surface modifiers can be selected from the various salts of aluminum, zirconium, titanium, zinc, cerium, boron, lithium, iron, and combinations thereof. Polymeric surface modifiers may include polyamines, polyacrylates, polyethylene glycol, polyethylene oxide, polyethylene imines, poly quaternary amines, polyphosphonates, polysulfonates, and combinations thereof. The organic surface modifiers may be selected from carboxylic acids, amines, phosphonates, organosilicones (or organosilanes), glycols, nonionic surfactants, quaternary amines, and combinations thereof. Surface modification can be carried out either during the silica-based composite synthesis or in a subsequent step. The surface modifiers are added in an amount equal to between about 1% and about 30% by weight silica-based particle composition.

The particle sols are formed by adding an amount of the silica-based particle active composition to an aqueous mixture. This is done such that the silica-based particle is added in an amount equal to between 1% and 50%. The water or aqueous carrier is added in an amount equal to between 1% and 50%. This can be done at ambient conditions. Also, additional additives can be included such as PEO, acrylamide polymers, or other polymers.

The silica-based particles and sols according to an embodiment of the present invention are aqueous and contain silica-based particles, i.e. particles based on silica (SiO₂) or silicic acid. The silica-based particles are preferably colloidal, having at least one particle dimension being less than 200 nm, i.e., in the colloidal range of particle size. The silica-based particles and sols may have an S-value within the range of from about 5% to 95%, suitably from about 10% to 50% and preferably from about 10% to 45%. The S-value can be measured and calculated as described by Iler & Dalton in J. Phys. Chem. 60 (1956), 955 957. The S-value indicates the degree of aggregate or microgel formation and a lower S-value is indicative of a higher degree of aggregation. The silica-based particle sols should suitably have a silica content of at least about 1% by weight, but it is more suitable that the silica content is within the range of from about 4% to 50% by weight, preferably from about 10% to 40% by weight, more preferably from about 15% to 30% by weight.

The silica-based particle sols may have a molar ratio of SiO₂ to M₂O, where M is alkali metal ion (e.g. Li, Na, K) and/or ammonium, within the range of from about 10:1 to 40:1, suitably from about 12:1 to 35:1, and preferably from about 15:1 to 30:1. The silica-based sols may have a pH of at least about 8.0, suitably at least about 9, preferably at least about 9.5. The pH can be up to about 11.5, suitably up to about 11.0. In another embodiment of this invention, the pH of the colloidal silica-based composites is between 2 and 5 and preferably between 3 and 4. A silica-based particle can be obtained by any known means in the art. Finally, the silica-based particles of this invention can have cationic, anionic, or neutral charge.

The silica-based particles present in the sol suitably have an average particle size below about 200 nm and preferably in the range of from about 3 to about 150 mm, more specifically, 5 and 100 nm, and more specifically, 10 and 30 nm. As is conventional in silica chemistry, particle size refers to the average size of the primary particles, which may be aggregated or non-aggregated. The specific surface area of the silica-based particles is suitably at least 10 m²/g SiO₂ and preferably at least between 200 m²/g and 300 m²/g. Generally, the specific surface area can be up to about 1,050 m²/g. In a preferred embodiment of this invention (as a retention and drainage aid), the specific surface area is within the range of from about 10 to 1,000 m²/g, preferably from about 575 to 900 m²/g. In another preferred embodiment of this invention, the specific surface area is within the range of from about 775 to 1,050 m²/g. The term “specific surface area,” as used herein, represents the average specific surface area of the silica-based particles and is expressed as square meters per gram of silica (m²/g SiO₂).

In order to simplify shipping and reduce transportation costs, it is generally preferable to ship high concentration silica-based sols. It is possible and usually preferable to dilute and mix the silica-based sols with water to substantially lower silica contents prior to use. For example, water may be added to adjust silica contents to at least about 0.05% by weight and preferably within the range of from about 0.05% to 5% by weight, in order to improve mixing with the furnished components. The viscosity of the silica-based sols may vary depending on, for example, the silica content of the sol. Usually, the viscosity is at least 5 centipoise (cP), normally within the range of from about 5 to 40 cP, suitably from about 6 to 30 cP, and preferably from about 7 to 25 cP. The viscosity, which is suitably measured on sols having a silica content of at least 10% by weight, can be measured by means of known technique, such as using a Brookfield LVDV II+ viscosimeter. Preferred silica-based sols of this invention are stable. In summary, these silica-based sols, when subjected to storage or aging for one month at 20° C. in dark and non-agitated conditions, can exhibit only a small increase in viscosity, if any.

The present invention provides for a method for the synthesis of unagglomerated, highly dispersed, stable composite particles. In an embodiment, the silica-based composite particles have dispersing agents such as alkylamine or alkylcarboxylic acid silane coupling agents attached thereon. In another embodiment, the dispersing agent may be selected from the group consisting of citrate, oxalate, succinate and phosphonates, or low molecular weight polyacrylic acids.

The foregoing may be better understood by reference to the following examples, which are intended for illustrative purposes and are not intended to limit the scope of the invention.

### Example 1

This example relates to the synthesis of a dye-coupling organosilane and incorporation of an active into silica. Two fluorescent dyes were coupled to an organic silane precursor and then incorporated into the silica utilizing a direct synthesis technique. By coupling dye to aminopropylsilane and adding it to an acid sol, incorporation of the dye resulted. In general, the reaction of coupling the dye to an organic silane precursor was done in two parts. First, smaller primary particles were grown with the coupled silane and acid sol. The coupled silane was a SiO₂ and active composition. Then additional acid sol was added to coat the primary particles which encapsulated the dye with a shell of silica.

In the present example, a dye coupled to an organosilane was formed as follows. In a round bottom flask, 0.07 mmol fluorescein isothiocyanate or 0.70 mmol rhodamine B was dissolved with 0.70 mmol aminopropyltrimethoxysilane in 10 mL anhydrous methanol. The solution was stirred overnight under N₂ thereby forming a dye-coupled organosilane or silica-based particle with an active.

Next an acid sol was formed to provide a source of silica. The source of silica for all samples was silicic acid (acid sol). The silicic acid was produced by passing a cold 8% sodium silicate solution through a column containing a cation exchange resin, Dowex 650C (H⁺) (available from The Dow Chemical Company in Midland, Mich.). About 40 mL of resin for 100 g of 8% sodium silicate solution was used.

To the freshly made acid sol (200 g) the dye-coupled organosilane suspended in 10 mL methanol, was added at 0° C. The solution was kept in an ice bath to prevent gelling of the acid sol. The acid sol/organosilane-dye was then added to a reaction flask containing a water heel (150 mL) with base (2.0 g 50% NaOH) as the catalyst. The flask was heated to 80° C. with agitation as the acid sol/organosilane-dye was added followed by 300 g acid sol at varying rates depending on the dye used and desired particle size. The solution was concentrated by ultra-filtration resulting in a final concentration of 20% by weight SiO₂.

Thus, both fluorescein and rhodamine B were coupled with an organic silane precursor and then incorporated into the silica independently. By employing the technique described above, the fluorescent dyes were incorporated into the inner region of a modified silica-based composite sol and were protected from external interferences such as quenching agents, bleaching agents, and pH changes.

### Example 2

In this example, organosilane-fluorescein tagged epoxy modified sol was formed. An organic modified silica-based composite sol was made through the direct synthesis method described in Example 1. It was mixed with an epoxy, to form a silica-based composite with an epoxy functional group incorporated therein. Amine, thiol, epoxy and other functional groups have been incorporated into silica-based composite sol.

To the freshly made acid sol (100 g) the fluorescein coupled organosilane in 10 mL methanol was added at 0° C. The solution was kept in an ice bath to prevent gelling of the acid sol. The acid sol/organosilane-fluorescein was then added to a reaction flask containing a water heel (150 mL) with base (1.0 g 50% NaOH) as the catalyst. The flask was heated to 80° C. with agitation as the acid sol/organosilane-fluorescein was added. 10 g of 3-glycidoxypropyltrimethoxysilane was added to 300 g acid sol and then the silane/acid sol was added to the heel. The final concentration of the solution was approximately 5% to 7% by weight SiO₂. The solution was concentrated via ultra-filtration. The final concentration was 15% SiO₂ (10% to 40%) by weight. The concentration of the fluorescein and silane can be varied, typically, 1% to 40% of the epoxy silane and 0.02% to 1% fluorescein by weight.

Again, by employing the technique described above, the fluorescent dyes were incorporated into the inner region of the modified silica-based composite sol and were protected from external interferences such as quenching agents, bleaching agents and pH changes. The ability to incorporate the organosilane-fluorescein dye into modified epoxy silica provides flexibility in the ultimate use of such materials.

### Example 3

An organosilane with fluorescein was synthesized and then combined with borosilicate to form an organosilane-fluorescein tagged borosilicate. The surface was modified with an inorganic and/or an organic surface modifier. Examples of inorganic surface modification include, but are not limited to, salts of aluminum, cerium, boron, lithium and iron. Other inorganic materials, such as zirconium, titanium, and zinc can be used to modify the surface. Examples of organic modifications include low molecular weight carboxylic acids, amines, phosphonates, organosilanes, glycols, nonionic surfactants, and quaternary amines. The surface modification agent may be present to modify the particle surface charge, hydrophobicity or as a means to place a fluorophore on the surface. The modification can be incorporated in the shell or throughout the whole of the silica-based nanocomposites. Borosilicate synthesis was performed as described in U.S. Pat. No. 6,270,627, “Use of Colloidal Borosilicates in the Production of Paper.”

To the freshly made 6.5% acid sol solution (130 mL) the fluorescein coupled organosilane in 10 mL methanol was added at 0° C. The solution was kept in an ice bath to prevent gelling of the acid sol. The acid sol/organosilane-fluorescein was then added to a reaction flask at 3 ml/min containing a water heel (20 mL), 0.025 M Borax (50 mL) and 0.1 N NaOH or NaOFI (60 mL). The solution was stirred an additional 2 hours. The final concentration was 7.5% (7.5% to 13%) solids with 0.039% (0.02% to 1%) fluorescein.

The technique employed synthesized an organosilane-fluorescein tagged borosilicate. As described above, the fluorescent dyes were incorporated into the inner region of the modified silica-based composite sol and were protected from external interferences such as quenching agents, bleaching agents and pH changes. The ability to incorporate the organosilane-fluorescein dye into borosilicate provides flexibility in the ultimate use of such materials.

### Example 4

In this example, some of the silica incorporated dyes were analyzed. Many additives in a formulation may quench the fluorescence of the dyes or influence the efficiency of the dyes. The dye may also leach from the silica-based composite sol. To determine the characteristics of the dye-incorporated silica-based composite sol, the silica characteristics were analyzed. The strength of the covalent binding of the dye to the silica was analyzed by determining the amount of dye that leached from the dye-incorporated silica and if the incorporated dye could interact with other dye molecules in the environment.

Using the direct synthesis technique of Example 1, fluorescein labeled silica-based composite sol particles were synthesized. Ultra-filtration was utilized to determine if the dye was incorporated and attached to the silica. The free dye composition (or unbound) in the solution passed through the filter (filter size) and was not retained. After a few wash cycles, the permeate was clear and a yellow silica-based nanocomposite sol solution was left. Not all of the dye was coupled to the silane thus full retention of the dye was not observed. The color in the colloidal particles remained and was concentrated to 10% to 15% SiO₂. The concentration of the fluorescein and silane varied, typically, 10% to 40% of the epoxy silane and 0.02% to 0.2% fluorescein by weight.

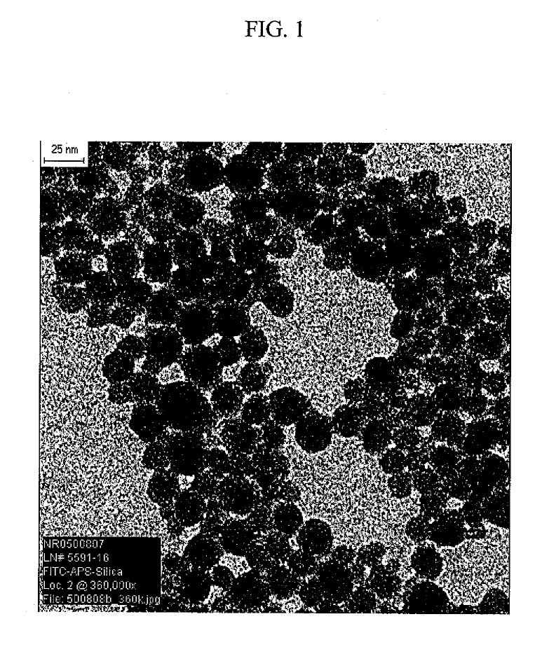

Also, the thiourea linkage was susceptible to hydrolysis in basic conditions, causing the thiourea linkage of the colloidal particles to potentially break and result in the loss of the dye. The particles were analyzed using a variety of devices. A transmission electron microscopy (TEM) device showed spherical particles ˜20 nm (FIG. 1). This compared well to the Quasielastic Light Scattering (QELS) data indicating a 23 nm particle size. The Brunauer, Emmett, and Teller (BET) surface area analysis was obtained on the dried silica indicated the particles had a surface area of 230 m²/g. (Table 1) From the BET results the estimated particle size was 12 nm. The dye and organosilane consisted of <1% of the total weight of the silica composition.

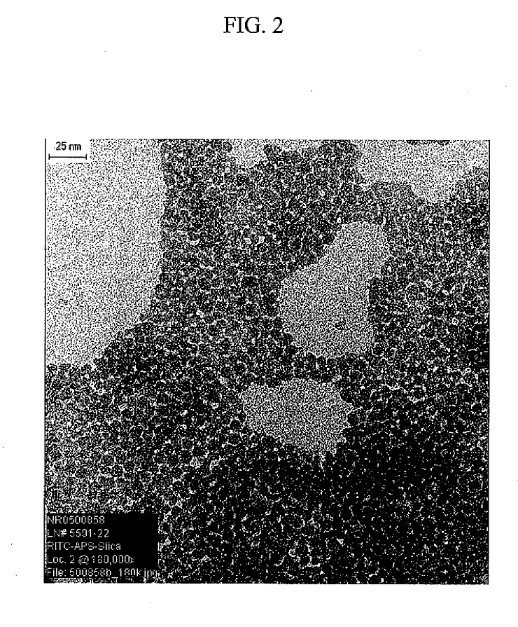

Rhodamine B tagged silica showed similar retention of the dye as fluorescein tagged silica, forming a transparent light red colloidal solution. The TEM image showed particles ˜6-8 nm and more agglomerated than the fluorescein tagged silica (FIG. 2). BET data obtained on the dried silica indicated a surface area of 276 m²/g with calculated particle size of 9.9 nm. Table 1 shows that the QELS indicated a larger particle size (22 nm) which is due to the QELS technique that detects the hydrodynamic volume of the particle composed of the colloidal particle and surrounding liquid.

TABLE 1
BET results for the fluorescent tagged silica

| | Fluorescein- | Rhodamine |
|---|---|---|
| | doped | B-doped |
| | Silica | Silica |
| Surface Area (m²/g) | 230 | 276 |
| Pore Volume (cc/g) | 0.256 | 0.332 |
| Pore Size (Å) | 44.6 | 48.2 |

### Example 5

The different rates of acid sol addition produced different particle size in the products. Thus, the particle size was controllable similar to the synthesis of pure silica-based composite sol. The colloidal particles were stable at least to 25% w/w solids. Further, both rhodamine B- and fluorescein-tagged silica showed similar dye retention indicating the covalent binding of the dye to the silica reduced the leaching of the dye from the silica-based composite sol.

### Example 6

The isothiocyanate derivatives of fluorescein and rhodamine B were coupled with 3-aminopropyltriethoxysilane producing a thiourea linkage between the isothiocyanate and silane. An infrared spectrum test was conducted, using standard protocols it was revealed that there was a reduction of the isothiocyanate group (2230 cm⁻¹) thus showing the dye coupled organosilane product was formed. A ¹³C NMR test was inconclusive and did not contribute to the determination of the structure. The mass spectrum was more helpful in exhibiting both product and starting material were present after overnight reaction time. If allowed to react longer, condensation of the silane groups occurred and the amount of product decreased in solution.

The dyes of Example 1 and 2 were tested using a UV absorbance test. The colloidal particles exhibited strong color in solution and as a solid. Alterations to fluorescent dyes have been known to alter the fluorescing characteristics of the dye. Therefore, the fluorescence emission and UV absorbance of the dye incorporating particles was analyzed in addition to environmental stability of the particles.

Two silica-based composite particles containing different concentrations of fluorescein (14 μg/ml based on 12% solids and 152 μg/ml based on 8.7% solids) were prepared with the concentrations of the fluorescein determined based on the molar absorptivity of free fluorescein ε₄₉₂=77,000 (c=A/λ). The fluorescein tagged borosilicate particle had similar properties to the non-tagged borosilicate. After particles were washed, it was found that 29 μg/ml fluorescein was incorporated in the particle at 7.5% solids.

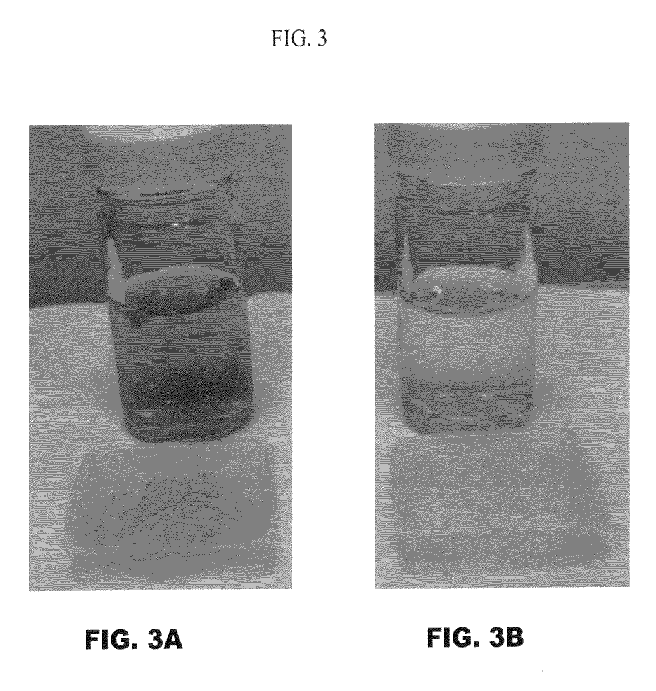

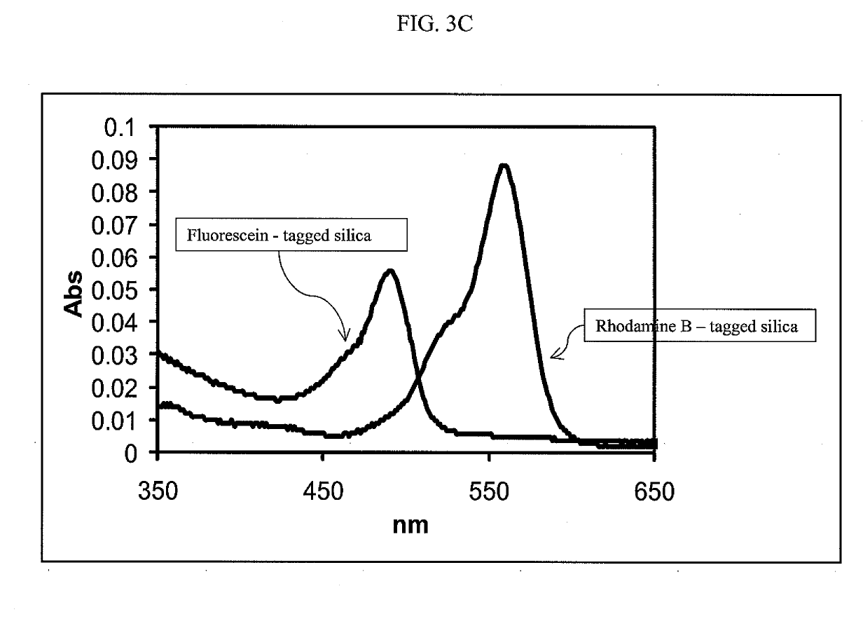

FIG. 3C shows the UV/Vis of fluorescein tagged silica and rhodamine B tagged silica. The colloidal particles exhibited strong color in solution and as a solid (FIG. 3A for rhodamine B and FIG. 3B for fluorescein). The UV absorbance was similar to the free dyes, fluorescein and rhodamine B in water (pH 9) with maximums at 490 nm and 560 nm, respectively. Fluorescein was sensitive to fluctuations in pH or solvent changes, where rhodamine B was more stable in different pH regimes. Fluorescein tagged silica in methanol exhibited relatively no change, where fluorescein isothiocyanate (FITC) broadened out and shifted to a longer wavelength.

The incorporation of the dyes was exemplified by excitation and emission which were similar to the free dyes. Fluorescein-tagged silica had an exₘₐₓ 492 nm and emₘₐₓ 512 nm and rhodamine B tagged silica had an exₘₐₓ 557 nm and emₘₐₓ 573 nm. These factors indicate that the dye was protected from external elements. To determine how efficient the dye was protected from exterior elements bleach was added to the colloidal solution. Bleach will neutralize free dye in solution and quench the fluorescence.

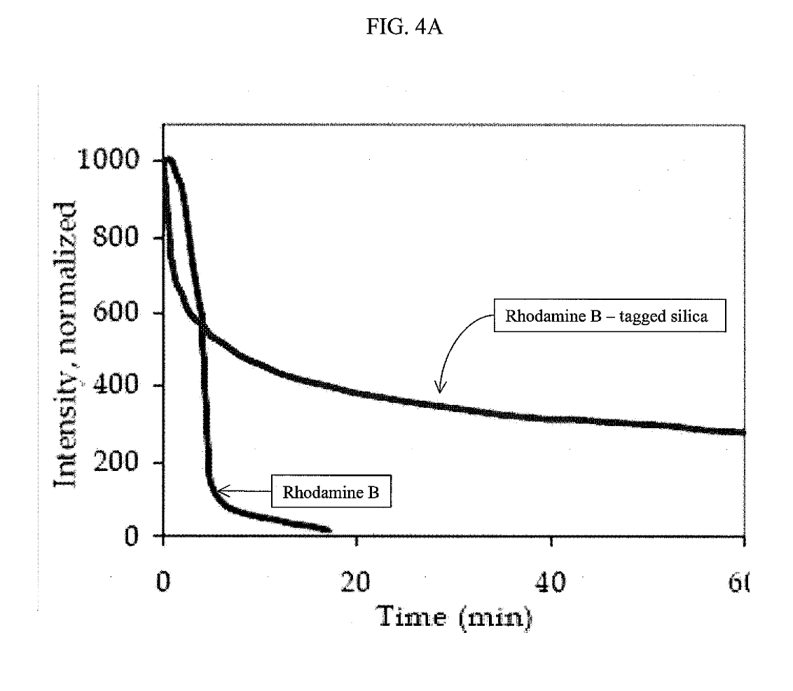

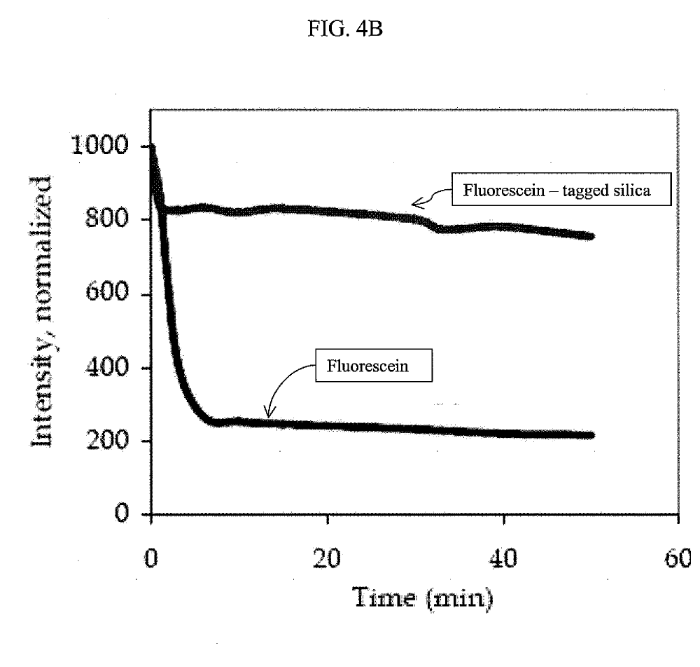

By tracking the emission over time the rate of photo- and/or chemical degradation can be followed. Particles of the silica-based particle with fluorescein and rhodamine in solution were compared to the corresponding free dyes. Fluorescein isothiocyanate had decreased emission immediately after the bleach was added and rhodamine β isothiocyanate had decreased emission within 45 minutes. Both of the silica-based particle with fluorescein and rhodamine showed some resistance to bleaching. Initially, the dye, which was not fully incorporated or on the surface, was chemically degraded at a rate similar to free dye in solution (FIGS. 4A and 4B). Some of the dye remained active and did not quench thus proving the dye was encapsulated and protected from solution changes.

Next a more gentle bleaching solution (hydrogen peroxide) was tested and the rhodamine-tagged silica exhibited better chemical resistance than free rhodamine B. Only 20% of the intensity was lost with the peroxide compared to 80% for the free dye. Another unique property of the tagged silica was the increase of the fluorescent intensity when the dye was incorporated into the silica (FIGS. 4A and 4B). At the same absorbance concentration, the fluorescent intensity increased 4-fold compared to the free dye in solution. The incorporation of the dye protected it from self-quenching and interaction with other dye molecules. As such, it was demonstrated that the silica-based composite sol formed a shell to protect the dye.

### Example 7

This example illustrates the synthesis of metal-coated tagged silica. The deionized fluorescein tagged silica was produced by passing 25% silica solution from Example 1 through a column containing the cation exchange resin, Dowex 650C (1+). The solution had a final concentration of 20% by weight SiO₂ at pH 3.5. 931 g of the 20% tagged SiO₂ was adjusted with acetic acid to a pH<3. In a flask, 100 g of 85% dihydroxy aluminum acetate stabilized with boric acid and 332 g water were blended and stirred until fully dissolved. Silica solution was fed into the aluminum acetate over 2 hours. The resulting solution had 14.5% Al/SiO₂ at pH 3.4 to 4.4.

### Example 8

This example illustrates modified metal-tagged silica. To freshly made acid sol (100 g) the fluorescein coupled organosilane in 10 mL methanol was added at 0° C. The solution was kept in an ice bath to prevent gelling of the acid sol. The acid sol/organosilane-fluorescein was then added to a reaction flask containing a water heel (150 mL) with base (1.0 g 50% NaOH) as the catalyst. The flask was heated to 80° C. with agitation as the acid sol/organosilane-fluorescein was added. A 0.5 g aluminum chlorohydrate 50% solution was added to 30 g acid sol and then the Al/acid sol was added to the heel. The final concentration of the solution was approximately 5% to 6% SiO₂. The solution was concentrated via ultra-filtration. The final concentration was 15% SiO₂ (10% to 40%). The concentration of the fluorescein and silane can be varied, typically, 0.1% to 1% aluminum and 0.02% to 0.2% fluorescein by weight.

### Example 9

Performance of the particles was tested in a paper flocculation test. Paper retention of fluorescein-tagged borosilicate and fluorescein tagged epoxy modified silica was analyzed. Focused Beam Reflectance Measurement (FBRM) was utilized to monitor flocculation of paper fiber. With FBRM, a solution of 300 mL with a SAF (20% GCC) was used. A standard dose was of 10 lb/t starch and 3 lb/t 61067 cationic flocculate. The particle dose was varied between 1 and 3 lb/t. The loss in activity could have been due to the fluorescein not being fully incorporated into the particle, thus, reducing the surface area of the particle. The particles were added to a sheet of paper using a dip-coat method or added in the wet-end of the formation of a hand sheet. Britt Jar method tested the retention of the particles by tracking the concentration of the fluorescein tagged epoxy modified silica not retained in the paper fiber.

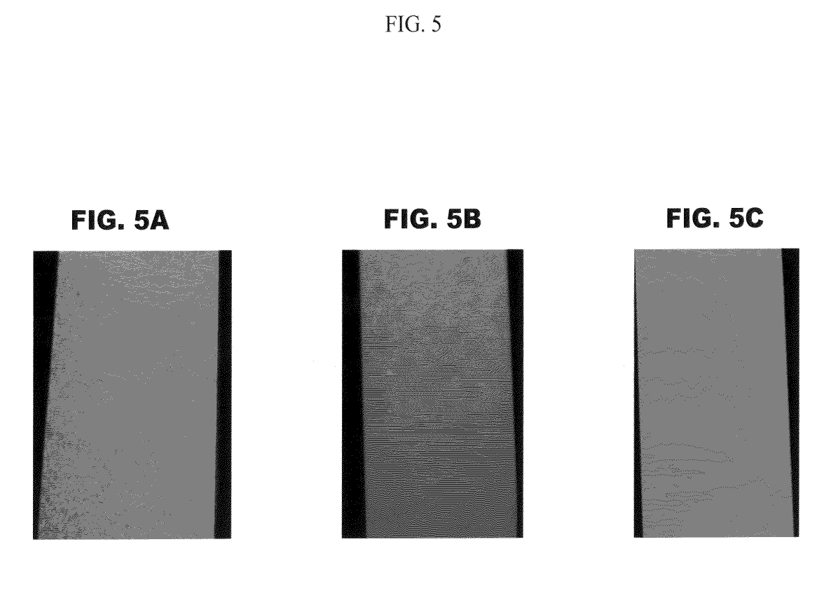

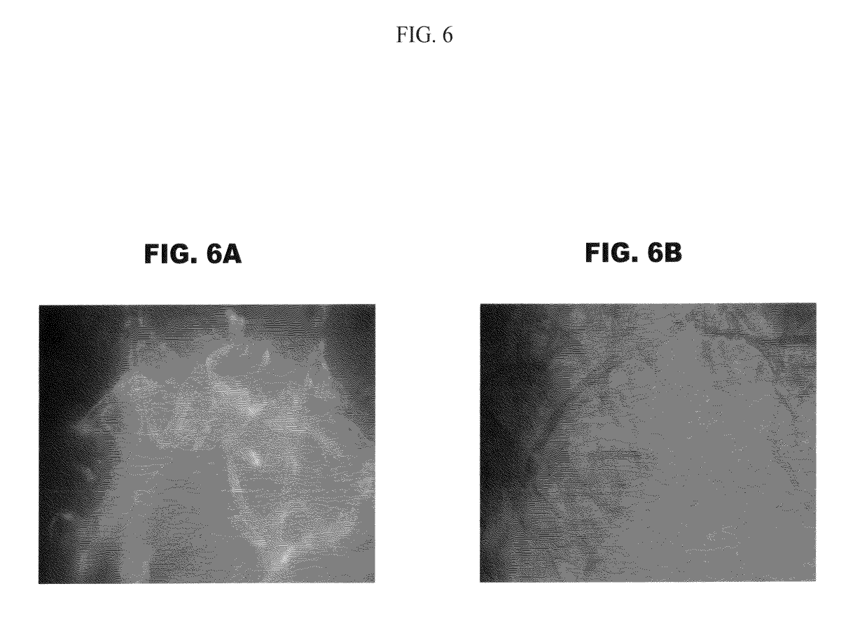

The fluorescent emission of the particles in the paper sheets was visible under UV light (365 nm) (FIG. 5). The particles were more evenly distributed throughout the whole sheet in the hand sheet compared to the dip-coated sheet which was more speckled. This was also evident with the paper sheets under a fluorescent microscope (FIG. 6). The fluorescent emission of the hand sheet was throughout the sheet. The particles were located in the filler and not concentrated on the fibers or the surface, whereas, the fluorescent emission on the dip coated sheet was concentrated on the fibers rather than in the filler.

In summary, the examples describe the synthesis and characterization of fluorescent tagged colloidal silica-based composite sols. A variety of modified/doped silica-based composites were tagged with a fluorescent molecule without a major effect on performance compared to the non-tagged derivative. The tagged silica slowed for the tracking of the silica throughout the paper making process.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated.

Any ranges given either in absolute terms or in approximate terms are intended to encompass both, and any definitions used herein are intended to be clarifying and not limiting. Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements and should be interpreted as including the term “about.” Moreover, all ranges disclosed herein are to be understood to encompass any and all subranges (including all fractional and whole values) subsumed therein.

Furthermore, the invention encompasses any and all possible combinations of some or all of the various embodiments described herein. Any and all patents, patent applications, scientific papers, and other references cited in this application, as well as any references cited therein, are hereby incorporated by reference in their entirety. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

The claimed invention is:

1. A composition including a silica-based compound of a general formula: (SiO₂)ₓ(OH)_{y}R_{z}, wherein (a) R is an active selected from the group consisting of: markers, amines, thiols, epoxies, organosilicones, organosilanes, water soluble agents, and combinations thereof, and (b) the weight ratio of y/x is from about 0.2 to about 0.5 and the weight ratio of z/x is from about 0.0001 to about 0.20.

2. The composition of claim 1, further comprising a substituent “S” and the silica-based compound has the general formula (SiO₂)ₓ(OH)_{y}R_{z}Sₜ, wherein (a) S is selected from the group consisting of: salts of aluminum, zirconium, titanium, zinc, cerium, boron, lithium, iron, low molecular weight carboxylic acids, amines, phosphonates, organosilicones, organosilanes, glycols, nonionic surfactants, quaternary amines, and combinations thereof; and (i) the weight ratio of t/x is from 0 to about 0.5.

3. The composition of claim 1, wherein the active is represented by the general formula R₍₄₋ₐ₎—SiXₐ, wherein a is from 1 to 3, X is a hydrolysable alkoxy group, and R is an aliphatic or alkene.

4. The composition of claim 1, wherein the water-soluble agent has an average molecular weight ranging from about 100 to about 1,000,000 and is selected from the group consisting of: amines, carboxylic acids, phosphonates, sulfonates, and combinations thereof.

5. The composition of claim 1, wherein the markers are selected from the group consisting of: fluorophores, dyes, and combinations thereof.

6. The composition of claim 1, wherein the markers are selected from the group consisting of: fluorophore; fluorescein and fluorescein derivatives; rhodamine B; fluorophane; tetrasodium 1,3,6,8-pyrenetetra sulfonate; optical brighteners; fluorescent whitening agents; acid dyes; reactive dyestuffs; direct dyestuffs; dye fixing agents; orange HE dyes; black dyes; bifunctional reactive dyes; and combinations thereof.

7. The composition of claim 1, wherein particles of the silica-based compound have a diameter ranging between about 3 nm and about 200 nm.

8. The composition of claim 1, wherein the particles of the silica-based compound have a diameter ranging between about 5 nm and about 200 nm.

9. The composition of claim 1, wherein particles of the silica-based compound are about 20 nm.

10. The composition of claim 1, wherein the silica-based compound comprises between about 5% to about 50% by weight SiO₂.

11. The composition of claim 1, wherein the silica-based compound comprises about 0.02% to about 2% by weight active.

12. The composition of claim 1, wherein the silica-based compound has a surface area ranging between about 10 m²/g and about 1,050 m²/g.

13. The composition of claim 1, wherein a silicon dioxide is used to form the composition and is selected from the group consisting of: silica, colloidal silica, polysilicate microgel, aluminosilicate, aluminum-modified-colloidal silica, ferrosilicate, borosilicate, titanium-silicate, natural clays, synthetic clays, acid sol, sodium silicate, tetraethylorthosilicate, and combinations thereof.

14. The composition of claim 1, further comprising a viscosity of at least about 5 centipoise.

15. A dye-coupled silica-based particle composition comprising: between about 5% and about 50% by weight SiO₂ and between about 0.02% and about 2% by weight of dye; wherein the particles are spherical and have a size ranging between about 10 nm and about 30 nm.
